(19) United States
(12) Patent Application Publication
(10) Pub. No.: US 2021/0083534 A1
(43) Pub. Date: Mar. 18, 2021

(54) MAGNET EMBEDDED TYPE MOTOR AND METHOD FOR MANUFACTURING THE SAME

(71) Applicant: TOYOTA JIDOSHA KABUSHIKI KAISHA, Toyota-shi (JP)

(72) Inventors: Mayumi TAKAZAWA, Okazaki-shi (JP); Fumitaka Yoshinaga, Toyota-shi (JP)

(73) Assignee: TOYOTA JIDOSHA KABUSHIKI KAISHA, Toyota-shi (JP)

(21) Appl. No.: 16/999,704

(22) Filed: Aug. 21, 2020

(30) Foreign Application Priority Data
Sep. 18, 2019 (JP) 2019-169045

(51) Int. Cl. H02K 1/27

(52) U.S. Cl. CPC H02K 1/276

(57) ABSTRACT

A magnet embedded type motor capable of reducing a counter electromotive voltage while improving a torque is provided. The magnet embedded type motor of the present disclosure includes a stator and a rotor rotatably disposed inside the stator. The stator includes a stator core and a coil wound around the stator core. The rotor includes a rotor core and a plurality of magnet groups embedded in the rotor core along a circumferential direction. The plurality of magnet groups form a plurality of respective magnetic poles. A magnetic material constituting the rotor core has a saturation magnetic flux density higher than a saturation magnetic flux density of a magnetic material constituting the stator core by 0.2 T or more.

### CROSS REFERENCE TO RELATED APPLICATIONS

The present application claims priority from Japanese patent application JP 2019-169045 filed on Sep. 18, 2019, the entire content of which is hereby incorporated by reference into this application.

### BACKGROUND

### Technical Field

The present disclosure relates to a magnet embedded type motor that includes a stator around which a coil is wound and a rotor rotatably disposed inside the stator, and a method for manufacturing the same.

### Description of Related Art

Conventionally, a motor that includes a stator around which a coil is wound and a rotor disposed inside the stator rotatably around a rotation axis with respect to the stator has been used. Among the motors, for example, a magnet embedded type motor (for example, IPM (Interior Permanent Magnet) motor) disclosed in JP 2017-147810 A includes a rotor core through which a rotary shaft is inserted, the rotor core is provided with magnet holes penetrating in a rotation axis direction, and magnets are embedded in the magnet holes.

### SUMMARY

In the above-described magnet embedded type motor, increase of the rotation speed of the rotor increases a counter electromotive voltage, thus causing a problem of increase of the counter electromotive voltage when the rotor rotates at a high speed. Meanwhile, when a magnetic flux density of a permanent magnet is decreased to reduce the counter electromotive voltage for suppressing the problem, its torque decreases.

The present disclosure has been made in view of the above-described problem, and the present disclosure provides a magnet embedded type motor capable of reducing a counter electromotive voltage while improving its torque.

To solve the above-described problems, a magnet embedded type motor of the present disclosure comprises a stator and a rotor rotatably disposed inside the stator. The stator includes a stator core and a coil wound around the stator core. The rotor includes a rotor core and a plurality of magnet groups embedded in the rotor core along a circumferential direction. The plurality of magnet groups form a plurality of respective magnetic poles. A magnetic material constituting the rotor core has a saturation magnetic flux density higher than a saturation magnetic flux density of a magnetic material constituting the stator core by 0.2 T or more.

The present disclosure can reduce the counter electromotive voltage while improving the torque.

In the present disclosure, the magnetic material constituting the rotor core is at least one selected from a nanocrystalline soft magnetic material, a magnetic steel, and a permendur, and the magnetic material constituting the stator core is an amorphous soft magnetic material in some embodiments. This is because a condition where the saturation magnetic flux density of the magnetic material constituting the rotor core is higher than that of the magnetic material constituting the stator core by 0.2 T or more is easily satisfied.

In the present disclosure, the magnetic material constituting the rotor core is the nanocrystalline soft magnetic material in some embodiments. This is because the productivity of the motor can be improved and the cost can be reduced.

### Effect

The present disclosure can reduce the counter electromotive voltage while improving the torque.

### BRIEF DESCRIPTION OF THE DRAWINGS

FIG. 1 is a schematic cross-sectional view illustrating a cross-sectional surface perpendicular to a rotation axis direction in an exemplary magnet embedded type motor of an embodiment according to the present disclosure;

FIG. 2 is an enlarged schematic cross-sectional view illustrating a ⅛ model of the magnet embedded type motor illustrated in FIG. 1;

FIG. 3 is a schematic perspective view of a stator core illustrated in FIG. 1;

FIG. 4 is a schematic perspective view of a rotor core illustrated in FIG. 1;

FIG. 5 is a graph illustrating values of saturation magnetic flux densities of an amorphous soft magnetic material, a nanocrystalline soft magnetic material, an electromagnetic steel, and a permendur;

FIG. 6 is a graph illustrating counter electromotive voltages of Examples 1 to 3 and Comparative Example; and

FIG. 7 is a graph illustrating maximum torques of Examples 1 to 3 and Comparative Example.

### DETAILED DESCRIPTION OF THE EMBODIMENTS

The following describes an embodiment according to a magnet embedded type motor of the present disclosure.

The magnet embedded type motor of the embodiment according to the present disclosure is a magnet embedded type motor that includes a stator and a rotor rotatably disposed inside the stator. The stator includes a stator core and a coil wound around the stator core. The rotor includes a rotor core and a plurality of magnet groups embedded in the rotor core along a circumferential direction. The plurality of magnet groups form a plurality of respective magnetic poles. A magnetic material constituting the rotor core has a saturation magnetic flux density higher than a saturation magnetic flux density of a magnetic material constituting the stator core by 0.2 T or more. In the following description of the embodiment, the “circumferential direction” and the “radial direction” mean the circumferential direction and the radial direction of the rotor core or metal plates (for example, metal foils made of a nanocrystalline soft magnetic material, magnetic steel sheets, or metal plates made of a permendur) laminated to form the rotor core; respectively, unless otherwise stated. The “rotation axis direction” means the direction of a rotation axis of the rotor. Furthermore, the “center” and the “outer periphery” mean the center and the outer periphery of the rotor core or the metal plates laminated to form the rotor core, respectively, in plan view from the rotation axis direction unless otherwise stated.

First, an exemplary magnet embedded type motor of the embodiment will be described.

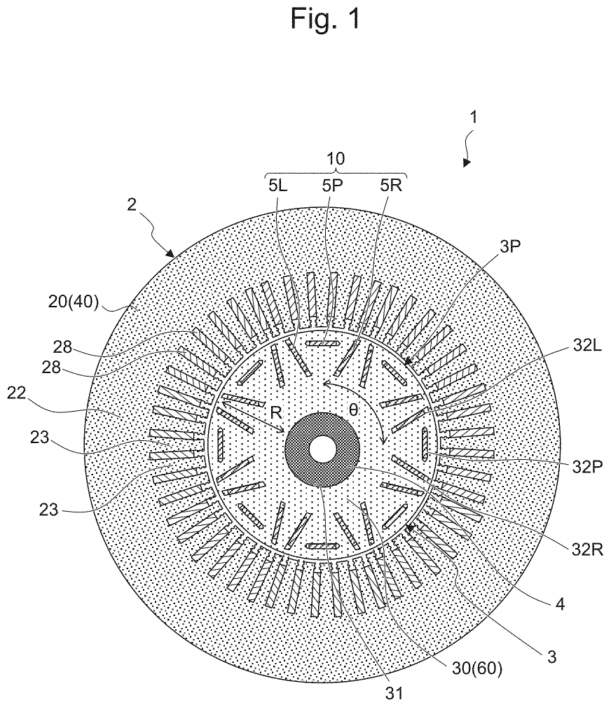

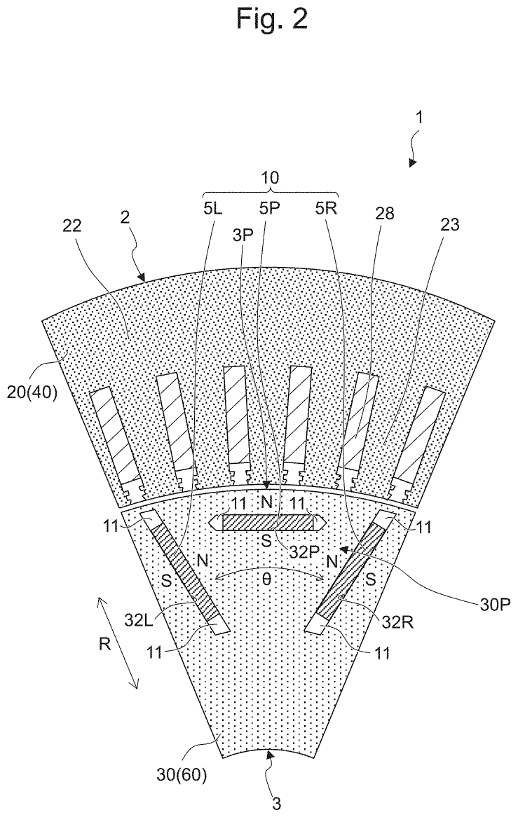

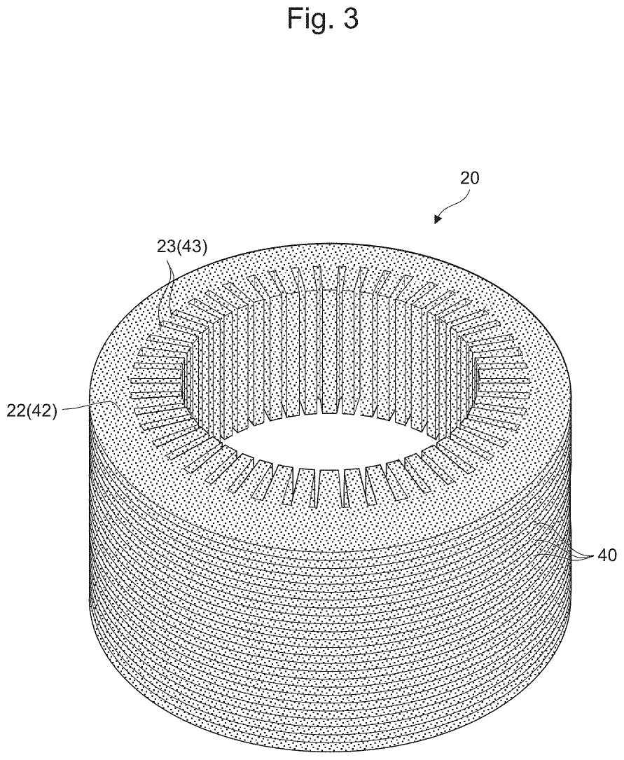

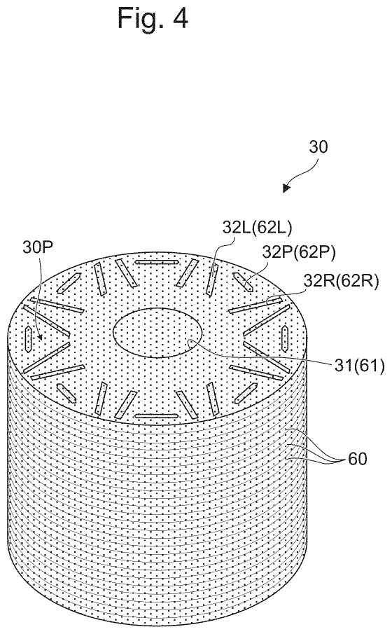

Here, FIG. 1 is a schematic cross-sectional view illustrating a cross-sectional surface perpendicular to the rotation axis direction in the exemplary magnet embedded type motor of the embodiment according to the present disclosure. FIG. 2 is an enlarged schematic cross-sectional view illustrating a ⅛ model of the magnet embedded type motor illustrated in FIG. 1. FIG. 3 is a schematic perspective view of a stator core illustrated in FIG. 1, and FIG. 4 is a schematic perspective view of a rotor core illustrated in FIG. 1.

As illustrated in FIG. 1 and FIG. 2, a magnet embedded type motor 1 of this example includes a stator 2 and a rotor 3 rotatably disposed inside the stator 2.

The stator 2 includes a stator core 20 and a plurality of coils 28 wound around the stator core 20. As illustrated in FIG. 3, the stator core 20 is a laminated body where a plurality of annular metal foils 40, which are made of an amorphous soft magnetic material, are laminated in their thickness direction.

As illustrated in FIG. 1 to FIG. 3, the stator core 20 includes an annular yoke (back yoke) 22 and a plurality of teeth 23 extending from an inner peripheral side of the yoke 22 to the rotor 3 side. The plurality of teeth 23 are formed at regular intervals along the circumferential direction of the yoke 22. The coils 28 are wound around the respective teeth 23. The coils 28 are disposed at regular intervals on the inner peripheral side of the stator core 20 in concentrated winding or distributed winding, and a rotating magnetic field to rotate the rotor 3 is generated when the coils 28 are energized. The yoke 22 is a part where a magnetic path of the magnetic field is formed. The plurality of metal foils 40 laminated to form the stator core 20 each include a yoke-forming portion 42 and a tooth-forming portion 43. The yoke 22 and the teeth 23 of the stator core 20 are formed of the yoke-forming portions 42 and the tooth-forming portions 43 included in the plurality of metal foils 40, respectively.

The rotor 3 includes a rotor core 30, a rotary shaft 4, and eight magnet groups 10. The rotary shaft 4 is inserted through a shaft hole 31 formed in the center of the rotor core 30, and the shaft hole 31 penetrates in the rotation axis direction. The eight magnet groups 10 are embedded in the rotor core 30 along a circumferential direction θ at every 45°. In the rotor 3, eight magnetic poles 3P are formed by the respective eight magnet groups 10. As illustrated in FIG. 4, the rotor core 30 is a laminated body where a plurality of circular metal foils 60, which are made of a nanocrystalline soft magnetic material, are laminated in their thickness direction. The plurality of metal foils 60 are each provided with a shaft hole 61 in the center, and the shaft hole 31 provided to the rotor core 30 is formed by the shaft holes 61 of the plurality of metal foils 60. The nanocrystalline soft magnetic material has a saturation magnetic flux density higher than that of the amorphous soft magnetic material by 0.2 T or more.

As illustrated in FIG. 1, FIG. 2, and FIG. 4, the rotor core 30 is provided with a pair of radially arranged magnet holes 32L, 32R for each magnetic pole 3P on an outer peripheral portion 30P where magnetic fluxes of the magnets are flown toward the stator 2. The pair of radially arranged magnet holes 32L, 32R extend in a radial direction R and penetrate in the rotation axis direction. Furthermore, the rotor core 30 is provided with a circumferentially arranged magnet hole 32P between outer peripheral side ends of the pair of radially arranged magnet holes 32L, 32R for each magnetic pole 3P. The circumferentially arranged magnet hole 32P extends in the circumferential direction θ and penetrates in the rotation axis direction. The plurality of metal foils 60 laminated to form the rotor core 30 are each provided with radially arranged magnet holes 62L, 62R and a circumferentially arranged magnet hole 62P, and the radially arranged magnet holes 32L, 32R and the circumferentially arranged magnet hole 32P of the rotor core 30 are formed by the radially arranged magnet holes 621, 62R and the circumferentially arranged magnet holes 62P provided to the plurality of metal foils 60, respectively.

The rotary shaft 4 is made of metal, and secured to the rotor core 30 by caulking and the like (not illustrated) in a state of being inserted through the shaft hole 31 of the rotor core 30. One magnet group 10 includes a pair of radially arranged magnets 5L, 5R extending in the radial direction R and a circumferentially arranged magnet 5P extending in the circumferential direction θ. As illustrated in FIG. 2, in the magnet group 10, the circumferentially arranged magnet 5P has the N-pole on the side adjacent to the stator 2, and has the S-pole on the opposite side. The pair of radially arranged magnets 5L, 5R are disposed so as to each have a polarity opposite to a polarity of the circumferentially arranged magnet 5P. That is, since the pair of radially arranged magnets 5L, 5R are close to the S-pole compared with the N-pole of the circumferentially arranged magnet 5P, the pair of radially arranged magnets 5L, 5R have the N-pole on the sides adjacent to the circumferentially arranged magnet 5P. While the illustration is omitted, in the rotor 3, the pair of radially arranged magnets 5L, 5R and the circumferentially arranged magnet 5P each have the N-pole and the S-pole opposite between the magnet groups 10 of the magnetic poles 3P mutually adjacent in the circumferential direction θ.

As illustrated in FIG. 1 and FIG. 2, in the rotor core 30, for each magnetic pole 3P, the pair of radially arranged magnets 5L, 5R are embedded in the pair of radially arranged magnet holes 321, 32R, and the circumferentially arranged magnet 5P is embedded in the circumferentially arranged magnet hole 32P. A resin 11 is filled in gaps on both end sides in the radial direction of the pair of radially arranged magnets 5L, 5R in the pair of radially arranged magnet holes 321, 32R, and the resin 11 is filled in gaps on both end sides in the circumferential direction of the circumferentially arranged magnet 5P in the circumferentially arranged magnet hole 32P.

In the magnet embedded type motor 1 of this example, the stator core 20 is a laminated body where the plurality of metal foils 40, which are made of the amorphous soft magnetic material, are laminated, and the rotor core 30 is a laminated body where the plurality of metal foils 60, which are made of the nanocrystalline soft magnetic material, are laminated. In addition, the nanocrystalline soft magnetic material has the saturation magnetic flux density higher than that of the amorphous soft magnetic material by 0.2 T or more. Accordingly, compared with a case where both the plurality of metal foils 40 laminated to form the stator core 20 and the plurality of metal foils 60 laminated to form the rotor core 30 are made of the amorphous soft magnetic material, the magnetic force is improved by the amount of the plurality of metal foils 60 laminated to form the rotor core 30 made of the nanocrystalline soft magnetic material, thereby ensuring the improvement of the maximum torque of the motor 1. The saturation magnetic flux density of the stator core 20 becomes lower than that of the rotor core 30, and further, the magnetic flux generated by the magnet group 10 flows so as to be closed inside the rotor core 30 and is less likely to flow to the stator core 20, thus reducing the magnetic flux interlinking across the coil 28 of the stator 2. Consequently, the counter electromotive voltage generated at the coil 28 of the stator 2 can be reduced.

Furthermore, the reduction of the counter electromotive voltage allows reduction of a field weakening current applied to the coil 28 of the stator 2 for performing a field weakening control, thereby ensuring suppression of torque reduction due to the field weakening control. The reduction of the counter electromotive voltage can enhance the output of the motor 1, and the reduction of the field weakening current can enhance the efficiency of the motor 1.

Therefore, the magnet embedded type motor according to the embodiment can reduce the counter electromotive voltage while improving the torque with the magnetic material constituting the rotor core that has the saturation magnetic flux density higher than that of the magnetic material constituting the stator core by 0.2 T or more like the magnet embedded type motor 1 of this example.

Subsequently, the configurations of the magnet embedded type motor of the embodiment will be each described in detail.

### 1. Rotor

The rotor includes the rotor core and the plurality of magnet groups that are embedded in the rotor core along the circumferential direction and form the respective plurality of magnetic poles. The magnetic material constituting the rotor core has the saturation magnetic flux density higher than that of the magnetic material constituting the stator core by 0.2 T or more.

Here, a method for measuring the saturation magnetic flux densities of the magnetic material constituting the rotor core and the magnetic material constituting the stator core includes, for example, a method using a vibrating sample magnetometer (VSM) for the measurement.

While the magnetic material constituting the rotor core is not specifically limited insofar as the saturation magnetic flux density is higher than that of the magnetic material constituting the stator core by 0.2 T or more, the magnetic material constituting the rotor core may be, for example, at least one selected from a nanocrystalline soft magnetic material, a magnetic steel, and a permendur, and is the nanocrystalline soft magnetic material or the like in some embodiments.

While the nanocrystalline soft magnetic material includes, for example, a material containing at least one magnetic metal selected from the group consisting of Fe, Co, and Ni and at least one non-magnetic metal selected from the group consisting of B, C, P, Al, Si, Ti, V, Cr, Mn, Cu, Y, Zr, Mo, Hf, Ta, and W, the nanocrystalline soft magnetic material is not limited to them.

While a representative material of the nanocrystalline soft magnetic material includes, for example, a FeCo alloy (FeCo, FeCoV, and the like), a FeNi alloy (FeNi, FeNiMo, FeNiCr, FeNiSi, and the like), a FeAl alloy or a FeSi alloy (FeAl, FeAlSi, FeAlSiCr, FeAlSiTiRu, FeAlO, and the like), a FeTa alloy (FeTa, FeTaC, FeTaN, and the like), and a FeZr alloy (FeZrN and the like), the material is not limited to them. In the case of the Fe alloy, Fe may be contained by 80 at % or more.

As another material of the nanocrystalline soft magnetic material, for example, a Co alloy that contains Co and at least one of Zr, Hf, Nb, Ta, Ti, or Y can be used. The Co alloy may contain Co by 80 at % or more. Such a Co alloy easily become amorphous in film formation, and is low in crystal magnetic anisotropy, crystal defect, and grain boundary, thus having extremely excellent soft magnetic property. The nanocrystalline soft magnetic material includes, for example, a CoZr alloy, a CoZrNb alloy, and a CoZrTa alloy in some embodiments.

For the nanocrystalline soft magnetic material, the nanocrystal has a crystallite diameter of less than 1 μm calculated from a half-value width of a diffraction peak in an X-ray diffraction by Scherrer's formula. In this embodiment, the crystallite diameter (crystallite diameter calculated from the half-value width of the diffraction peak in the X-ray diffraction by the Scherrer's formula) of the nanocrystal may be 100 nm or less, or 50 nm or less. The crystallite diameter of the nanocrystal may be 5 nm or more. The crystallite diameter of the nanocrystal is this size, thereby improving the soft magnetic property. A conventional magnetic steel has the crystallite diameter in the order of μm, and typically 50 μm or more.

The nanocrystalline soft magnetic material has a nanocrystalline structure, and the diffraction peak is observed at a position corresponding to a grid interval on a crystal face. The crystallite diameter can be calculated from the width of the diffraction peak using the Scherrer's formula. The nanocrystalline structure of the nanocrystalline soft magnetic material can be formed by heating the amorphous soft magnetic material to a crystallization starting temperature or more and keeping it at a temperature of the crystallization starting temperature or more for a predetermined time. Here, as apparent from Examples described later, the nanocrystalline soft magnetic material has saturation magnetization higher than that of the amorphous soft magnetic material.

When the magnetic material constituting the rotor core is the nanocrystalline soft magnetic material, while the rotor core is not specifically limited, the rotor core may be formed by laminating, for example, metal foils made of the nanocrystalline soft magnetic material like the rotor core 30 illustrated in FIG. 1. The thickness of the metal foil made of the nanocrystalline soft magnetic material may be, for example, in a range of 0.01 mm to 0.05 mm. This is because by setting to the upper limit or less of the range, a loss during the use of the motor can be suppressed.

The magnetic steel includes a silicon steel and the like. When the magnetic material constituting the rotor core is a magnetic steel, while the rotor core is not specifically limited, the rotor core may be formed by laminating, for example, magnetic steel sheets (silicon steel sheets and the like). The thickness of the magnetic steel sheet is, for example, in a range of 0.1 mm to 0.5 mm.

The permendur includes Fe-49Co-2V and the like. When the magnetic material constituting the rotor core is the permendur, while the rotor core is not specifically limited, the rotor core includes, for example, a rotor core formed by compression molding of a powder for magnetic core containing a soft magnetic powder made of the permendur, and a rotor core formed by laminating metal sheets made of the permendur.

While the plurality of magnet groups are not specifically limited insofar as they are embedded in the rotor core along the circumferential direction, usually, like the eight magnet groups 10 illustrated in FIG. 1, the plurality of magnet groups are embedded in the rotor core along the circumferential direction at regular intervals.

While the rotor core is not specifically limited insofar as the magnet holes in which the magnet group is embedded are provided for each of the magnetic poles, the rotor core includes a rotor core where, for example, a pair of radially arranged magnet holes extending in the radial direction in the outer peripheral portion and a circumferentially arranged magnet hole extending in the circumferential direction between outer peripheral side ends of the pair of radially arranged magnet holes are formed as the magnet holes for each of the magnetic poles like the rotor core 30 illustrated in FIG. 1. Here, the “outer peripheral portion” means a region on the outer peripheral side of the rotor core where the magnetic flux of the magnet is flown toward the stator like the outer peripheral portion 30P illustrated in FIG. 2.

While the magnet group is not specifically limited, the magnet group includes, for example, a magnet group that includes a pair of radially arranged magnets embedded in the pair of radially arranged magnet holes and a circumferentially arranged magnet that extends in the circumferential direction and is embedded in the circumferentially arranged magnet hole like the magnet group 10 illustrated in FIG. 1. The magnets included in the magnet group are permanent magnets. While the shape of the magnet is not specifically limited, the shape includes, for example, a rectangular parallelepiped shape where a planar shape is a rectangular shape having long sides and short sides and a side shape is a rectangular shape having long sides and short sides in plan view from the rotation axis direction like the pair of radially arranged magnets 5L, 5R and the circumferentially arranged magnet 5P illustrated in FIG. 1.

The permanent magnet includes a ferrite magnet, an alnico magnet, and the like in addition to a rare earth magnet, such as a neodymium magnet containing neodymium, iron, and boron as main components and a samarium cobalt magnet containing samarium and cobalt as main components.

In the rotor, the resin may be filled in the gaps on both end sides of the radially arranged magnet in the radially arranged magnet hole like the rotor 3 illustrated in FIG. 1. Similarly, the resin may be filled in the gaps on both end sides of the circumferentially arranged magnet in the circumferentially arranged magnet hole. The resin includes, for example, a thermosetting resin excellent in formability and heat resistance. The thermosetting resin includes an epoxy resin, a polyimide resin, and the like.

In the rotor, while an adhesive layer of a heat resistant resin and the like may be disposed between the metal plates (for example, a metal foil made of a nanocrystalline soft magnetic material, a magnetic steel sheet, or a metal plate made of permendur) laminated to form the rotor core, the adhesive layer does not need to be disposed insofar as the lamination state of the metal plate is maintained. The heat resistant resin includes a thermosetting resin and the like. The thermosetting resin includes an epoxy resin, a polyimide resin, a polyamide-imide resin, an acrylic resin, or the like.

### 2. Stator

The stator includes the stator core and the coil wound around the stator core.

While the magnetic material constituting the stator core is not specifically limited insofar as the saturation magnetic flux density is lower than that of the magnetic material constituting the rotor core by 0.2 T or more, for example, the amorphous soft magnetic material may be used as the magnetic material constituting the stator core.

While the amorphous soft magnetic material includes, for example, a material containing at least one magnetic metal selected from the group consisting of Fe, Co, and Ni, and at least one non-magnetic metal selected from the group consisting of B, C, P, Al, Si, Ti, V, Cr, Mn, Cu, Y, Zr, Nb, Mo, Hf, Ta, and W, the nanocrystalline soft magnetic material is not limited to them.

While a representative material of the amorphous soft magnetic material includes, for example, a FeCo alloy (FeCo, FeCoV, and the like), a FeNi alloy (FeNi, FeNiMo, FeNiCr, FeNiSi, and the like), a FeAl alloy or a FeSi alloy (FeAl, FeAlSi, FeAlSiCr, FeAlSiTiRu, FeAlO, and the like), a FeTa alloy (FeTa, FeTaC, FeTaN, and the like), and a FeZr alloy (FeZrN and the like), the material is not limited to them. In the case of the Fe alloy, Fe may be contained by 80 at % or more.

As another material of the amorphous soft magnetic material, for example, a Co alloy that contains Co and at least one of Zr, Hf, Nb, Ta, Ti, or Y can be used. The Co alloy may contain Co by 80 at % or more. Such a Co alloy easily become amorphous in film formation, and is low in crystal magnetic anisotropy, crystal defect, and grain boundary, thus having extremely excellent soft magnetic property. The amorphous soft magnetic material includes, for example, a CoZr alloy, a CoZrNb alloy, and a CoZrTa, alloy in some embodiments.

The amorphous soft magnetic material is a soft magnetic material that has an amorphous structure as a main structure. In the case of the amorphous structure, the X-ray diffraction pattern does not have an apparent peak, and only a broad halo pattern is observed.

When the magnetic material constituting the stator core is the amorphous soft magnetic material, while the stator core is not specifically limited, the stator core may be formed by laminating, for example, metal foils made of the amorphous soft magnetic material. The thickness of the metal foil made of the amorphous soft magnetic material may be, for example, in a range of 0.01 mm to 0.05 mm. This is because by setting to the upper limit or less of the range, a loss during the use of the motor can be suppressed.

The coil is not specifically limited insofar as a rotating magnetic field to rotate the rotor is generated by energization. The coils are, for example, disposed at regular intervals on the inner peripheral side of the stator core in distributed winding or concentrated winding like the coil 28 illustrated in FIG. 1.

### 3. Magnet Embedded Type Motor and Method for Manufacturing the Sane

While the magnet embedded type motor is not specifically limited insofar as the magnet embedded type motor includes the stator and the rotor rotatably disposed inside the stator, for example, the magnet embedded type motor may be a motor where the magnetic material constituting the rotor core is at least one selected from a nanocrystalline soft magnetic material, a magnetic steel, and a permendur, and the magnetic material constituting the stator core is an amorphous soft magnetic material. This is because the condition where the saturation magnetic flux density of the magnetic material constituting the rotor core is higher than that of the magnetic material constituting the stator core by 0.2 T or more is easily satisfied. Among the motor and the like, the magnet embedded type motor is, for example, a motor where the magnetic material constituting the rotor core is a nanocrystalline soft magnetic material like the magnet embedded type motor 1 illustrated in FIG. 1 in some embodiments. This is because the rotor core and the stator core can be manufactured from the same amorphous soft magnetic material, thereby ensuring the improvement of the productivity of the motor to reduce the cost. The magnet embedded type motor is used as, for example, a drive source of a hybrid Vehicle and an electric vehicle.

While the method for manufacturing the magnet embedded type motor is not specifically limited insofar as the manufacturing method is capable of manufacturing the magnet embedded type motor of the embodiment, for example, the method includes: a rotor core metal plate preparing step of preparing a plurality of rotor core metal plates having shapes corresponding to a shape of a rotor core, the plurality of rotor core metal plates being provided with a plurality of magnet holes along a circumferential direction; a stator core metal plate preparing step of preparing a plurality of stator core metal plates having shapes corresponding to a shape of a stator core; a rotor manufacturing step of manufacturing the rotor by laminating the plurality of rotor core metal plates in a thickness direction of the rotor core metal plate such that positions of the plurality of magnet holes mutually match in plan view from a rotation axis direction to manufacture the rotor core provided with the plurality of magnet holes along the circumferential direction, and subsequently embedding a plurality of magnet groups in the plurality of respective magnet holes of the rotor core; and a stator manufacturing step of manufacturing the stator by laminating the plurality of stator core metal plates. A magnetic material constituting the rotor core metal plate has a saturation magnetic flux density higher than a saturation magnetic flux density of a magnetic material constituting the stator core metal plate by 0.2 T or more. The rotor core metal plate may be a metal foil made of a nanocrystalline soft magnetic material, a magnetic steel sheet, a metal plate made of permendur, or the like. The stator core metal plate may be, for example, a metal foil made of an amorphous soft magnetic material.

The method for manufacturing the magnet embedded type motor may be, for example, a method where a metal foil made of the nanocrystalline soft magnetic material is prepared as the rotor core metal plate by heating the metal foil made of the amorphous soft magnetic material to transform it to the metal foil made of the nanocrystalline soft magnetic material in the rotor core metal plate preparing step, and a metal foil made of the amorphous soft magnetic material is prepared as the stator core metal plate in the stator core metal plate preparing step. This is because the rotor core and the stator core can be manufactured from the metal foils made of the same amorphous soft magnetic material, thereby ensuring the improvement of the productivity of the motor to reduce the cost.

The method of heating the metal foil made of the amorphous soft magnetic material to transform it to the metal foil made of the nanocrystalline soft magnetic material is not specifically limited insofar as the metal foil is hearted to a temperature equal to or more than the crystallization starting temperature and kept to the temperature equal to or more than the crystallization starting temperature for a predetermined time. For example, the method may be a method where the metal foil is heated to a temperature that is the crystallization starting temperature or more and less than the compound precipitation starting temperature and kept to the temperature that is the crystallization starting temperature or more and less than the compound precipitation starting temperature for a predetermined time. This is because the precipitation of the compound that causes deterioration in soft magnetic property can be suppressed, Such a method includes, for example, a method of heating the metal foil to 430° C. and keeping the metal foil at 430° C. for five seconds. Here, the “crystallization starring temperature” means a temperature at which the crystallization starts when the metal foil made of the amorphous soft magnetic material is heated. The “compound precipitation starting temperature” means a temperature at which the precipitation of the compound as a by-product, such as Fe₂B, starts when the metal foil after the crystallization start is further heated.

### EXAMPLES

The following further specifically describes the embodiment according to the present disclosure with examples and a comparative example.

### Example 1

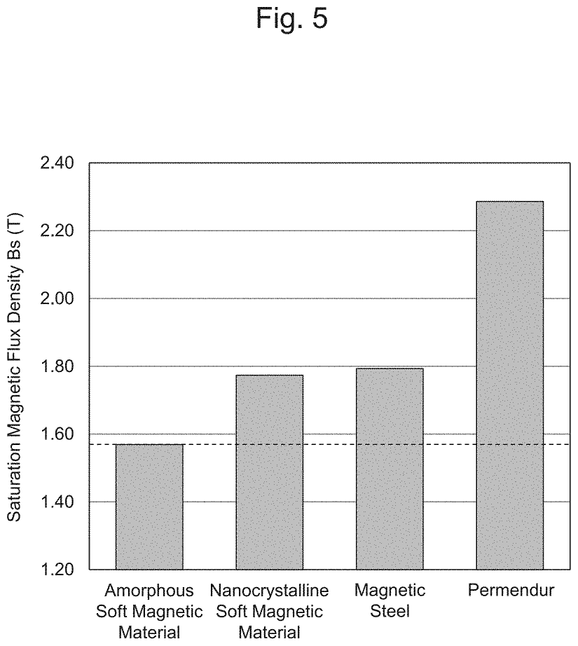

An analytical model of the magnet embedded type motor illustrated in FIG. 1 to FIG. 4 was prepared. As indicated in Table 1 below, a physical property of the amorphous soft magnetic material was given to the entire stator core, and a physical property of the nanocrystalline soft magnetic material was given to the entire rotor core. The physical properties of the amorphous soft magnetic material and the nanocrystalline soft magnetic material used for the analytical model are physical properties, such as a saturation magnetic flux density measured in advance. FIG. 5 is a graph that indicates values of the saturation magnetic flux density of the amorphous soft magnetic material, the nanocrystalline soft magnetic material, the magnetic steel, and the permendur. Table 2 below indicates the values of the saturation magnetic flux density of the amorphous soft magnetic material, the nanocrystalline soft magnetic material, the magnetic steel, and the permendur.

### Example 2

As illustrated in Table 1 below, an analytical model was prepared similarly to Example 1 excluding that a physical property of the magnetic steel was given to the entire rotor core. The physical property of the magnetic steel used for the analytical model is a physical property, such as a saturation magnetic flux density measured in advance.

### Example 3

As illustrated in Table 1 below, an analytical model was prepared similarly to Example 1 excluding that a physical property of the permendur was given to the entire rotor core. The physical property of the permendur used for the analytical model is a physical property, such as a saturation magnetic flux density measured in advance.

### Comparative Example

As illustrated in Table 1 below, an analytical model was prepared similarly to Example 1 excluding that a physical property of the amorphous soft magnetic material was given to the entire rotor core. The physical property of the amorphous soft magnetic material used for the analytical model is a physical property, such as a saturation magnetic flux density measured in advance.

TABLE 1

| | Stator Core | Rotor Core |
|---|---|---|
| Example 1 | Amorphous Soft | Nanocrystalline Soft |
| | Magnetic Material | Magnetic Material |
| Example 2 | Amorphous Soft | Magnetic Steel |
| | Magnetic Material | |
| Example 3 | Amorphous Soft | Permendur |
| | Magnetic Material | |
| Comparative | Amorphous Soft | Amorphous Soft |
| Example | Magnetic Material | Magnetic Material |

TABLE 2

| | Saturation Magnetic |
|---|---|
| | Flux Density Bs (T) |
| Amorphous Soft | 1.57 |
| Magnetic Material | |
| Nanocrystalline Soft | 1.77 |
| Magnetic Material | |
| Magnetic Steel | 1.79 |
| Permendur | 2.29 |

### [Evaluation of Counter Electromotive Voltage and Maximum Torque]

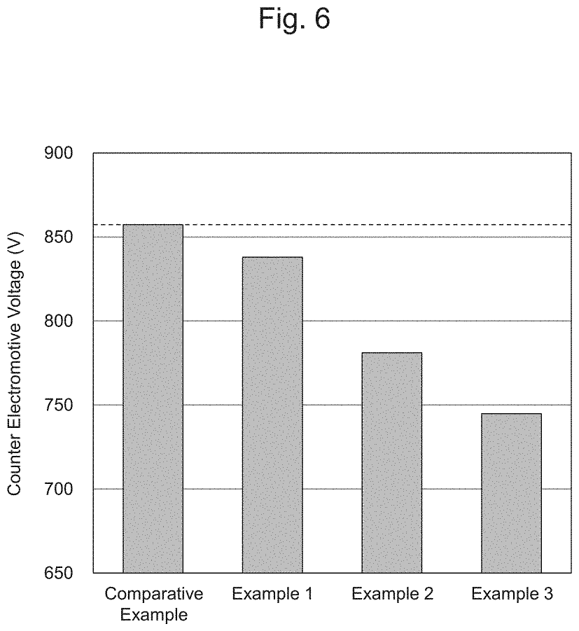

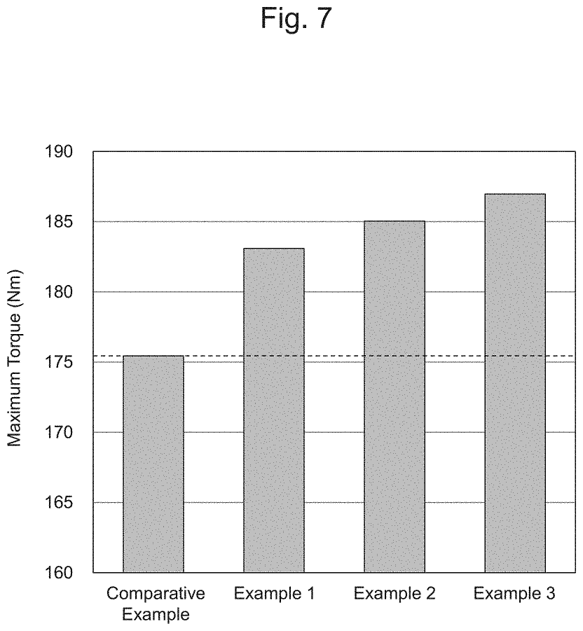

The counter electromotive voltage and the maximum torque when the rotation speed of the rotor was the maximum rotation speed were calculated using the analytical models of Examples 1 to 3 and Comparative Example. FIG. 6 is a graph indicating the counter electromotive voltages of Examples 1 to 3 and Comparative Example, and FIG. 7 is a graph indicating the maximum torque of Examples 1 to 3 and Comparative Example.

As illustrated in FIG. 6 and FIG. 7, in any of Examples 1 to 3, the counter electromotive voltage decreased and the maximum torque improved compared with Comparative Example as the conventional example. In Examples 1 to 3, as the saturation magnetic flux densities of the materials of the rotor core increased, the counter electromotive voltages significantly decreased and the maximum torque significantly improved.

While the embodiment of the present disclosure has been described in detail above, the present disclosure is not limited thereto, and can be subjected to various kinds of changes in design without departing from the spirit and scope of the present disclosure described in the claims.

All publications, patents and patent applications cited in the present description are herein incorporated by reference as they are.

### DESCRIPTION OF SYMBOLS

1 Magnet embedded type motor
2 Stator
20 Stator core
28 Coil
40 Metal foil made of amorphous soft magnetic material
3 Rotor
30 Rotor core
30P Outer peripheral portion
60 Metal foil made of nanocrystalline soft magnetic material
3P Magnetic pole
10 Magnet group
5L, 5R Radially arranged magnet
5P Circumferentially arranged magnet

What is claimed is:

1. A magnet embedded type motor comprising:
a stator; and
a rotor rotatably disposed inside the stator,
wherein the stator includes a stator core and a coil wound around the stator core,
wherein the rotor includes a rotor core and a plurality of magnet groups embedded in the rotor core along a circumferential direction, and the plurality of magnet groups form a plurality of respective magnetic poles, and
wherein a magnetic material constituting the rotor core has a saturation magnetic flux density higher than a saturation magnetic flux density of a magnetic material constituting the stator core by 0.2 T or more.

2. The magnet embedded type motor according to claim 1,
wherein the magnetic material constituting the rotor core is at least one selected from a nanocrystalline soft magnetic material, a magnetic steel, and a permendur, and the magnetic material constituting the stator core is an amorphous soft magnetic material.

3. The magnet embedded type motor according to claim 2,
wherein the magnetic material constituting the rotor core is the nanocrystalline soft magnetic material.
